(19) United States
(12) Patent Application Publication
(10) Pub. No.: US 2018/0203283 A1
(43) Pub. Date: Jul. 19, 2018

(54) PLASTIC FRAME, BACKLIGHT MODULE AND DISPLAY DEVICE

(71) Applicants: BOE Technology Group Co., Ltd., Beijing (CN); BOE Optical Science and Technology Co., Ltd., Suzhou (CN)

(72) Inventor: Xiaozeng PEI, Beijing (CN)

(21) Appl. No.: 15/575,641

(22) PCT Filed: May 19, 2017
(86) PCT No.: PCT/CN2017/085062

§ 371 Date: Nov. 20, 2017

(30) Foreign Application Priority Data
May 31, 2016 (CN) 201620518560.0

(51) Int. Cl. G02F 1/1333; G02F 1/1335

(52) U.S. Cl. CPC G02F 1/133308; G02F 1/133602

(57) ABSTRACT

Embodiments of the present disclosure provide a plastic frame, a backlight module and a display device. The plastic frame is used for a backlight module, and a recess is formed at a bending portion of the plastic frame.

### CROSS-REFERENCE TO RELATED APPLICATION

This application is a Section 371 National Stage Application of International Application No. PCT/CN2017/085062, filed on May 19, 2017, entitled “PLASTIC FRAME, BACKLIGHT MODULE AND DISPLAY DEVICE”, which claims priority to Chinese Patent Application No. 201620518560.0 filed on May 31, 2016 with SIPO, incorporated herein by reference in entirety.

### BACKGROUND

### Technical Field

Embodiments of the present disclosure relate to a field of display technology, and more particularly, to a plastic frame, a backlight module and a display device.

### Description of the Related Art

At present, liquid crystal display (LCD) devices become mainstream display devices in the field of display technology due to their advantages of low power consumption, low radiation, thinner body and softer picture. The liquid crystal display device is filled with liquid crystal, but the liquid crystal itself does not emit light, so the liquid crystal display device needs a backlight module as a light source.

### SUMMARY

In an aspect, an embodiment of the present disclosure provides a plastic frame for a backlight module, wherein a recess is formed at a bending portion of the plastic frame.

Optionally, the plastic frame includes four sidewalls connected together head-to-tail to form an annular shape, and inner surfaces of two adjacent sidewalls are connected to each other by a first arc surface concaved towards an outside of the plastic frame.

Optionally, the plastic frame includes four sidewalls connected together head-to-tail to form an annular shape, an inner surface of each sidewall is provided with a protruding edge perpendicular to the sidewall, and inner surfaces of two adjacent protruding edges are connected to each other by a second arc surface concaved towards an outside of the plastic frame.

Optionally, the inner surfaces of two adjacent sidewalls are connected to each other by the second arc surface.

Optionally, a central angle of the first arc surface is greater than 180°.

Optionally, the central angle of the first arc surface is 180° to 270°.

Optionally, a central angle of the second arc surface is greater than 180°.

Optionally, the central angle of the second arc surface is 180° to 270°.

Optionally, a radius of a circle corresponding to the second arc surface is less than or equal to ½ of a distance between the inner surface of the protruding edge and an outer surface of the sidewall corresponding to the protruding edge.

Optionally, the radius of the circle corresponding to the second arc surface is ¼ to ½ of the distance between the inner surface of the protruding edge and the outer surface of the sidewall corresponding to the protruding edge.

Optionally, the plastic frame further includes a filling block accommodated in the recess.

Optionally, the filling block is made of a same material as the plastic frame.

Optionally, the filling block has a shape that matches the recess.

In another aspect, an embodiment of the present disclosure provides a backlight module, including the plastic frame according to any one of the above embodiments.

In still another aspect, an embodiment of the present disclosure provides a display device, including the backlight module according to any one of the above embodiments.

### BRIEF DESCRIPTION OF THE DRAWINGS

In order to more clearly describe technical solutions in embodiments of the present disclosure or in the related art, the accompanying drawings required for describing the embodiments or the related art will be briefly introduced. It is apparent that the accompanying drawings in the following description only represent some of embodiments of the present disclosure, other drawings may be obtained by those skilled in the art based on these drawings without any creative work.

FIG. 1 is a schematic structural view of a plastic frame;

FIG. 2 is an enlarged view of an area A in FIG. 1;

FIG. 3 is a schematic structural view of a plastic frame according to an embodiment of the present disclosure;

FIG. 4 is an enlarged view of an area B in FIG. 3;

FIG. 5 is a schematic structural view of a plastic frame according to another embodiment of the present disclosure;

FIG. 6 is an enlarged view of an area C in FIG. 5; and

FIG. 7 is a plastic frame including a filling block according to an embodiment of the present disclosure.

### DETAILED DESCRIPTION OF PREFERRED EMBODIMENTS

The technical solutions in the embodiments of the present disclosure will be clearly and completely described below with reference to the accompanying drawings in the embodiments of the present disclosure. It is apparent that the described embodiments only represent some of those in the present disclosure, rather than all of embodiments. All other embodiments obtained by those skilled in the art based on the embodiments of the present disclosure without creative efforts fall within the scope of the present disclosure.

In the related art, the backlight module generally includes a back plate, a light bar, an optical component, and the like. Since the backlight module in the display device needs to be attached to a display panel, the backlight module also includes a plastic frame for carrying the display panel to be attached. In the related art, the plastic frame is generally formed from four sidewalls connected together head-to-tail, which are connected to each other, and the connection between the adjacent sidewalls is generally of a right-angled structure. However, such a right-angled structure would cause stress concentration there, such that it may easily be broken, damaged or the like during testing and assembling, thereby decreasing the yield of the backlight module and increasing the production cost of the backlight module.

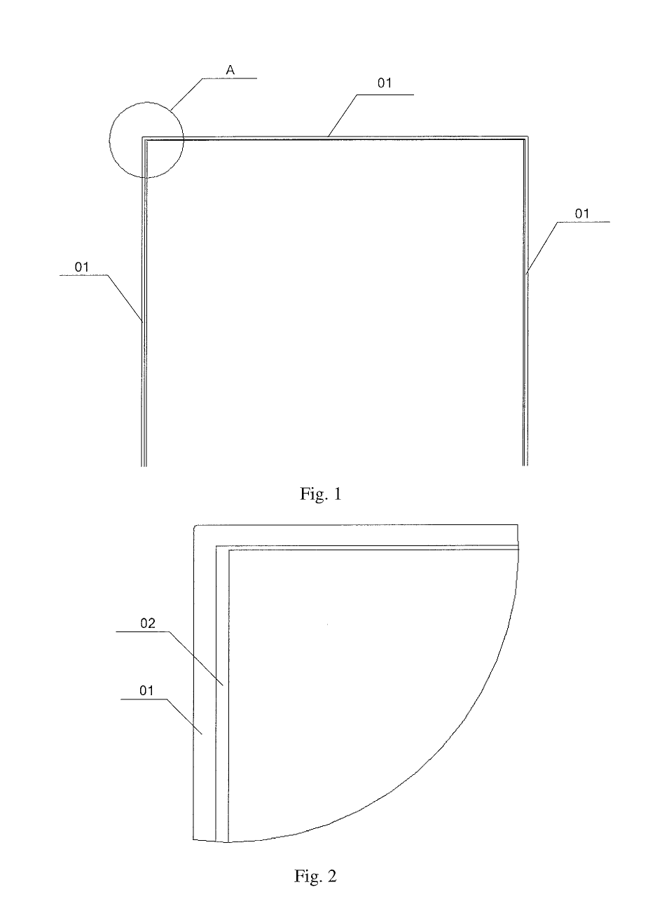

As shown in FIGS. 1 and 2, FIG. 2 is an enlarged view of an area A in FIG. 1, the plastic frame is formed from four sidewalls 01 connected together head-to-tail to form an annular shape, an inner surface of the sidewall 01 is provided with a protruding edge 02 perpendicular to the sidewall 01, the connection between the adjacent sidewalls 01 or the adjacent protruding edges 02 is of a right-angled structure. Although the protruding edges are provided, the right-angled structure still causes stress concentration here, such that it may easily be broken, damaged or the like during testing and assembling, thereby decreasing the yield of the backlight module and increasing the production cost of the backlight module.

An embodiment of the present disclosure provides a plastic frame for a backlight module, wherein a recess is formed at a bending portion of the plastic frame.

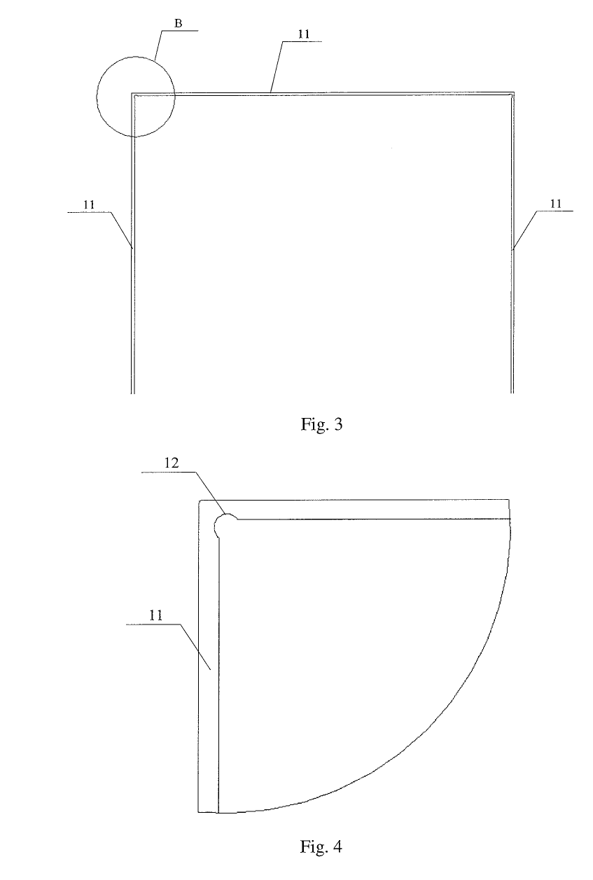

In an embodiment of the present disclosure, as shown in FIG. 3 and FIG. 4, the plastic frame includes four sidewalls 11 connected together head-to-tail to form an annular shape, and inner surfaces of two adjacent sidewalls 11 are connected to each other by a first arc surface 12 concaved towards an outside of the plastic frame.

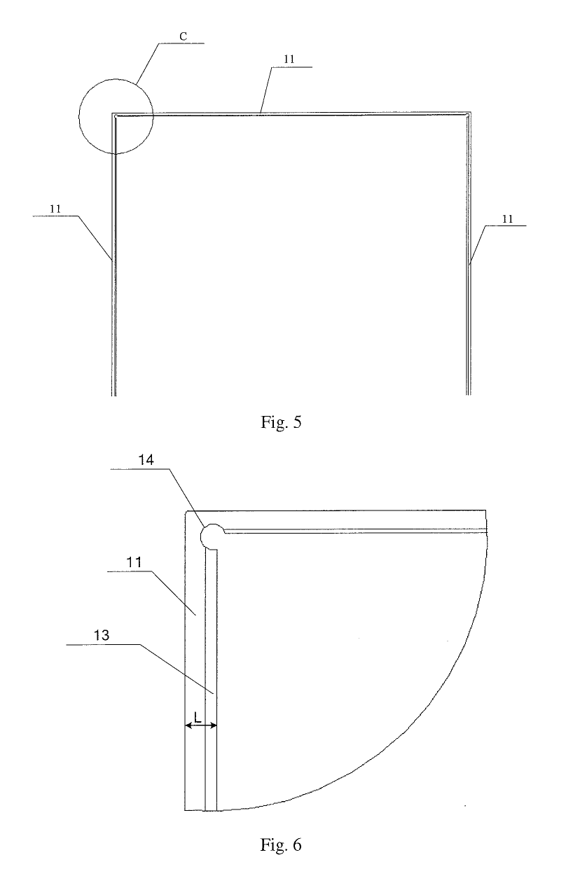

In another embodiment of the present disclosure, as shown in FIG. 5 and FIG. 6, the plastic frame includes four sidewalls 11 connected together head-to-tail to form an annular shape, an inner surface of each sidewall 11 is provided with a protruding edge 13 perpendicular to the sidewall 11, and inner surfaces of two adjacent protruding edges 13 are connected to each other by a second arc surface 14 concaved towards an outside of the plastic frame.

The embodiments of the present disclosure do not limit the values of central angles of the first arc surface 12 and the second arc surface 14 and the radii of the circles corresponding to the first arc surface 12 and the second arc surface 14. They may be determined by those skilled in the art according to specific conditions. In addition, the first arc surface 12 and the second arc surface 14 may have the same size, or alternatively, the first arc surface 12 and the second arc surface 14 may have different sizes, which will not be limited in the embodiments of the present disclosure.

Since the connection between the inner surfaces of two adjacent sidewalls 11 is generally of a right-angled structure in the related art, and the stress at the right-angled structure is relatively concentrated, the right-angled structure of the plastic frame can be easily broken or damaged during subsequent testing and assembling, thereby decreasing the yield of the backlight module. In the embodiments of the present disclosure, the connection between the adjacent sidewalls 11 or the adjacent protruding edges 13 in the plastic frame is configured to have an arc surface structure, that is, the right-angled structure is changed to a rounded-corner structure to reduce the stress at the connection. In this way, the toughness of the plastic frame is increased, thereby increasing the production yield of the backlight module and reducing the production cost of the backlight module.

Referring to FIG. 4 and FIG. 6, the inner surfaces of two adjacent sidewalls 11 are connected to each other by the first arc surface 12, and the first arc surface 12 is concaved toward the outside of the plastic frame; or, the inner surfaces of two adjacent protruding edges 13 are connected to each other by the second arc surface 14, and the second arc surface 14 is concaved toward the outside of the plastic frame. In this way, it addresses the stress problem at the corner between the adjacent sidewalls 11 or the adjacent protruding edges 13 without reducing the inner area of the plastic frame.

It should be noted that, in practical applications, all the corners between the four sidewalls 11 or the protruding edges 13 of the plastic frame may be configured to have an arc surface structure, or alternatively, a part of the corners between the four sidewalls 11 or the protruding edges 13 of the plastic frame may be configured to have an arc surface structure, which will not be limited in the embodiments of the present disclosure.

In an embodiment of the present disclosure, as shown in FIG. 5 and FIG. 6, if the inner surface of the sidewall 11 is provided with the protruding edge 13, the inner surfaces of two adjacent sidewalls 11 are also connected to each other by the second arc surface 14.

Referring to FIG. 6, if the inner surface of the sidewall 11 is provided with the protruding edge 13, the inner surfaces of the adjacent sidewalls 11 and the inner surfaces of the protruding edges 13 on the corresponding sidewalls 11 are both connected to each other by the second arc surface 14. In this way, the stress at the corners of the plastic frame can be released more thoroughly to further improve the toughness of the plastic frame.

In an embodiment of the present disclosure, a central angle of the second arc surface 14 is greater than 180°, so as to prevent the size of the area for placing light source, optical film or the like in the plastic frame being limited.

In an embodiment of the present disclosure, the central angle of the second arc surface 14 is 180° to 270°. The plastic frame having the second arc surface 14 of such an arc can better address the stress problem at the corners.

In an embodiment of the present disclosure, a central angle of the first arc surface 12 is also greater than 180°, so as to prevent the size of the area for placing light source, optical film or the like in the plastic frame being limited.

In an embodiment of the present disclosure, the central angle of the first arc surface 12 is 180° to 270°. In this way, it can better address the stress problem at the corners between sidewalls of the plastic frame.

In an embodiment of the present disclosure, as shown in FIG. 6, a radius of a circle corresponding to the second arc surface 14 is less than or equal to ½ of a distance L (i.e., a total thickness of the protruding edge 13 and the sidewall 11 where the protruding edge is located) between the inner surface of the protruding edge 13 and an outer surface of the sidewall 11 corresponding to the protruding edge 13. In this way, it not only addresses the stress concentration problem at the corners of the plastic frame, but also ensures the strength of the plastic frame.

In an embodiment of the present disclosure, the radius of the circle corresponding to the second arc surface 14 is ¼ to ½ of the distance L between the inner surface of the protruding edge 13 and the outer surface of the sidewall 11 corresponding to the protruding edge 13. This radius ratio can further ensure the strength of the plastic frame, thereby increasing the toughness of the plastic frame.

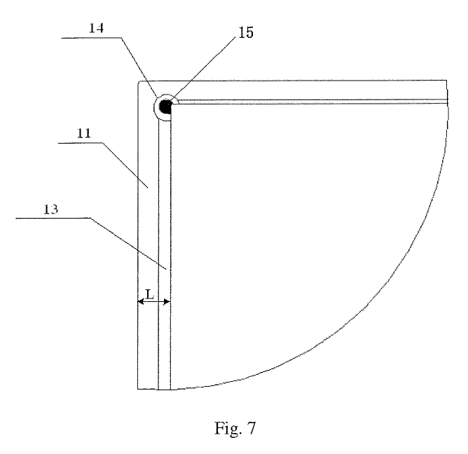

In an embodiment of the present disclosure, the plastic frame includes a filling block 15 accommodated in the recess, as shown in FIG. 7. The filling block is made of the same material as the plastic frame, and the filling block has a shape that matches the recess. By means of providing the filling block in the plastic frame, the structural strength of the plastic frame can be improved, and the plastic frame cannot be easily broken during transportation and usage.

According to the plastic frame in accordance with the embodiments of the present disclosure, the plastic frame is applied for a backlight module, and the plastic frame includes four sidewalls connected together head-to-tail to form an annular shape, and inner surfaces of two adjacent sidewalls are connected to each other by a first arc surface concaved towards an outside of the plastic frame; or, the plastic frame includes four sidewalls connected together head-to-tail to form an annular shape, an inner surface of each sidewall is provided with a protruding edge perpendicular to the sidewall, and inner surfaces of two adjacent protruding edges are connected to each other by a second arc surface concaved towards an outside of the plastic frame. Compared with the related art, in the embodiments of the present disclosure, the connection between the adjacent sidewalls or the adjacent protruding edges in the plastic frame is made to have an arc surface structure, and thus the stress at the connection is reduced. In this way, it overcomes the disadvantage that the plastic frame is easily broken or worn during testing or assembling, due to the stress concentration at the right-angled structure of the plastic frame in the case that the connection between the adjacent sidewalls is of the right-angled structure in the related art. Therefore, the toughness of the plastic frame is increased, thereby increasing the production yield of the backlight module and reducing the production cost of the backlight module.

Another embodiment of the present disclosure provides a backlight module, including the plastic frame according to any one of the above embodiments. If the plastic frame is applied to the backlight module, the production yield of the backlight module can be increased and the production cost of the backlight module can be reduced.

According to still another embodiment of the present disclosure, there is provided a display device, including the backlight module according to any one of the above embodiments. If the backlight module including the plastic frame is applied to the display device, the production yield of the display device can be increased and the production cost of the display device can be reduced.

The foregoing descriptions only represent specific embodiments of the present disclosure, but the scope of the present disclosure is not limited thereto. Any changes and substitutions made by those skilled in the art based on the technical scope disclosed in the present disclosure should fall within the scope of the present disclosure. Therefore, the scope of the present disclosure should be defined by the appended claims.

What is claimed is:

1. A plastic frame for a backlight module, wherein a recess is formed at a bending portion of the plastic frame.

2. The plastic frame according to claim 1, wherein the plastic frame comprises four sidewalls connected together head-to-tail to form an annular shape, and inner surfaces of two adjacent sidewalls are connected to each other by a first arc surface concaved towards an outside of the plastic frame.

3. The plastic frame according to claim 1, wherein the plastic frame comprises four sidewalls connected together head-to-tail to form an annular shape, an inner surface of each sidewall is provided with a protruding edge perpendicular to the sidewall, and inner surfaces of two adjacent protruding edges are connected to each other by a second arc surface concaved towards an outside of the plastic frame.

4. The plastic frame according to claim 3, wherein the inner surfaces of two adjacent sidewalls are connected to each other by the second arc surface.

5. The plastic frame according to claim 2, wherein a central angle of the first arc surface is greater than 180°.

6. The plastic frame according to claim 5, wherein the central angle of the first arc surface is 180° to 270°.

7. The plastic frame according to claim 3 or 4, wherein a central angle of the second arc surface is greater than 180°.

8. The plastic frame according to claim 7, wherein the central angle of the second arc surface is 180° to 270°.

9. The plastic frame according to claim 3 or 4, wherein a radius of a circle corresponding to the second arc surface is less than or equal to ½ of a distance between the inner surface of the protruding edge and an outer surface of the sidewall corresponding to the protruding edge.

10. The plastic frame according to claim 9, wherein the radius of the circle corresponding to the second arc surface is ¼ to ½ of the distance between the inner surface of the protruding edge and the outer surface of the sidewall corresponding to the protruding edge.

11. The plastic frame according to claim 1, further comprising a filling block accommodated in the recess.

12. The plastic frame according to claim 11, wherein the filling block is made of a same material as the plastic frame.

13. The plastic frame according to claim 11, wherein the filling block has a shape that matches the recess.

14. A backlight module, comprising the plastic frame according to any one of claims 1 to 13.

15. A display device, comprising the backlight module according to claim 14.
